(19) United States
(12) Patent Application Publication
(10) Pub. No.: US 2025/0308158 A1
(43) Pub. Date: Oct. 2, 2025

(54) Interactive Container Placement in a Map Module

(71) Applicant: William James Eaton, JR., HUDSON, NH (US)

(72) Inventor: William James Eaton, JR., HUDSON, NH (US)

(21) Appl. No.: 18/623,805

(22) Filed: Apr. 1, 2024

(51) Int. Cl. G06T 17/05; G06F 3/04845

(52) U.S. Cl. CPC G06T 17/05; G06F 3/04845; G06F 2203/04806

(57) ABSTRACT

This invention introduces an innovative system and method for integrated virtual container placement and truck visualization within a map module, tailored for container rental and delivery services. The system empowers customers to adjust container position and orientation via a user-friendly map interface, enhancing precision and efficiency in placement. Key technical advancements include the seamless integration of virtual container placement and truck visualization functionalities within a single map module, leading to improved operational efficiency and reduced errors. The principle use of the system is to facilitate accurate virtual container placement according to customer preferences, optimizing delivery logistics in container rental and delivery services.

### FIELD OF INVENTION

The field of the invention relates to interactive Delivery Management Systems (DMS) for Temporary On-Site Container Placement. This invention finds application in the delivery and placement of various on-site containers, including storage and refuse containers for residential, commercial, and construction purposes, waste management refuse containers, portable restrooms, and mobile offices.

### BACKGROUND

Renting storage and refuse containers is a common practice among homeowners, businesses, and government agencies seeking temporary storage and waste management solutions. These containers, some resembling those used in cargo transportation, typically weigh between 2000 to 10000 lbs and commonly come in standard sizes of 10, 20, or 40 feet. They are often directional, meaning they have specific orientations or configurations that impact their placement and delivery. Delivering these containers presents logistical challenges due to space requirements, communication for precise placement, and considerations regarding container direction or orientation.

Misconceptions among customers regarding the space needed for delivery pose a significant hurdle. A clear pathway of 70 to 120 feet is necessary to accommodate both the container and the truck and customers often underestimate the truck's size resulting in unexpected spatial constraints and delivery complications. Additionally, the orientation of the container's doors adds complexity, as customers must specify whether they want the doors facing towards the cab or the rear of the truck, crucial for efficient unloading upon delivery.

Another major challenge is accurately describing where to place the container. Customers are often required to be present during delivery to provide instructions. Alternatively, they may leave instructions via email or by marking the desired location, which can be challenging.

Municipalities and regulatory bodies have established guidelines and permit procedures governing container placement to ensure safety and compliance with local regulations. However, these regulations vary across jurisdictions, highlighting the need for a comprehensive container placement system.

These challenges can lead to wasted time, frustrated customers, and even safety hazards during delivery. Our innovative system aims to streamline storage and refuse container delivery processes. By integrating visual tools and user-friendly interfaces, our system clarifies the delivery requirements, ensures spatial awareness, and facilitates clear communication of door orientation preferences. Ultimately, this enhances customer satisfaction and operational efficiency in container rentals and waste management services.

### SUMMARY

In one embodiment of the invention, a system for interactive container placement in a map module is provided. This system comprises a dispatcher interface, facilitating input of container placement information, including the generation and emailing of a hyperlink to open a customer map module. The customer interface, accessed via this hyperlink, allows adjustment of a container-marker's position and orientation. Furthermore, the system enables real-time updating of a database with the container's coordinates, orientation, zoom, and heading during customer interaction.

Upon completion of the placement process by the customer, the system triggers transmission of an email notification to the dispatcher. Additionally, a driver interface is included, allowing the designated driver to view the specified container placement. Moreover, within this system, there exists a control to show/hide a truck-visualization-marker within the map module. This feature enables customers to visualize the space required for container delivery by displaying a virtual representation of a truck or delivery vehicle on the map interface.

Furthermore, controls within the map module facilitate clockwise and counterclockwise rotation of the container-marker in predetermined increments, along with the ability to flip it 180 degrees for optimal door positioning.

In another embodiment, when the map zoom level is adjusted, both the container-marker and the truck-visualization-marker dynamically scale to accurately reflect their sizes relative to the map viewport. Additionally, the system incorporates a button within the map interface for adding extra container-markers and ensuring marker orientation synchronizes with changes in map heading. Movement of the container-marker by a customer results in synchronous movement of the truck-visualization-marker within the map interface, facilitating coordinated visualization of container placement and truck space requirements. The dispatcher interface offers settings for marker and truck fill and line colors, preset orientation intervals, and access rights to the map configuration module.

In another aspect of the invention, a method for interactive container placement and visualization is provided. This method involves initializing a map module on a customer interface, adjusting the zoom level, and allowing the customer to drag the container-marker to adjust its position on the map. Moreover, customers can rotate the container-marker in predetermined increments for precise orientation adjustments. Additionally, the method includes displaying a truck visualization marker feature within the map module, allowing customers to visualize the space needed for container delivery. A toggle control within the map module flips the container-marker 180 degrees, adjusting container door orientation if necessary. Customers can also change the heading of the map interface, dynamically adjusting the orientation of the container-marker and truck visualization marker.

Furthermore, the method allows customers to make final adjustments to the container-marker position, rotation, or orientation during the placement process. Finalizing the container placement process triggers transmission of placement data stored in the database and notification to relevant parties. Additionally, the container-marker and truck visualization marker dynamically scale relative to the map viewport as the zoom level is adjusted, facilitating smooth interaction with the system.

In another aspect of the invention, a non-transitory computer-readable medium stores instructions for operations including initializing a map module on a customer interface, enabling customer manipulation of a container-marker within the map module, and real-time updating of a database upon manipulation of the container-marker by the customer.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 is a view of a block diagram illustrating the system's implementation, showcasing the core components and their interactions.

FIG. 2 is a view of the dispatcher interface for managing container placement requests, highlighting key functionalities.

FIG. 3 is a view of the dispatcher settings interface, allowing customization of the container placement system's appearance and functionality.

FIG. 4 is a view of the customer interface for container placement, providing intuitive controls for specifying placement preferences and visualization.

FIG. 5 is a view of the driver interface for container placement retrieval to ensure accurate delivery and retrieval processes.

FIG. 6 is a view of a block diagram outlining the method's implementation, depicting the sequential steps involved in the container placement process.

FIG. 7A-K are views of detailed functionalities offered by the customer interface for container placement, including features such as marker rotation, flip, and a truck-visualization marker.

FIG. 8 is a view of the system functionality for container and dumpster customization, presenting options for color customization.

FIG. 9 is a view of the system functionality for truck visualization customization, presenting options for custom colors.

FIG. 10 is a view that demonstrates the system's marker rotation capabilities, allowing customers to precisely adjust the orientation of containers on the map interface.

FIG. 11 is a view that illustrates the dragging of the markers and how the system updates the location.

FIG. 12 is a view that demonstrates the synchronized dragging functionality of the system, allowing customers to seamlessly drag both the container and truck-visualization markers.

FIG. 13 is a view that showcases an embodiment of an add container control designed to allow customers to add additional container markers on the map interface.

FIG. 14 is a view that illustrates how the markers maintain their relative size in comparison to the map, regardless of the zoom level.

### DETAILED DESCRIPTION OF THE INVENTION

The following description, in conjunction with the accompanying drawings, aims to provide a comprehensive understanding of exemplary embodiments of the interactive container placement in a map module system, as defined by the claims and their equivalents. The system streamlines the process of visualizing, selecting, and confirming container placement locations for efficient delivery logistics. It presents various specific details to facilitate this understanding, but these examples are intended to be illustrative rather than exhaustive. Therefore, those skilled in the art will recognize that numerous changes and modifications can be made to the embodiments described herein without departing from the scope and essence of the invention. Additionally, descriptions of well-known functions commonly used in container logistics management systems may be omitted for clarity and brevity.

The terms and expressions used in the following description and claims are not restricted to their bibliographical meanings but are employed by the inventor to ensure a clear and consistent comprehension of the invention. Consequently, it should be evident to those skilled in the art that the description of exemplary embodiments provided herein is for illustrative purposes only and is not intended to limit the invention as defined by the appended claims and their equivalents.

It is to be understood that the singular forms “a,” “an,” and “the” encompass plural referents unless the context clearly dictates otherwise. Thus, references to “a container-marker” include one or more such markers.

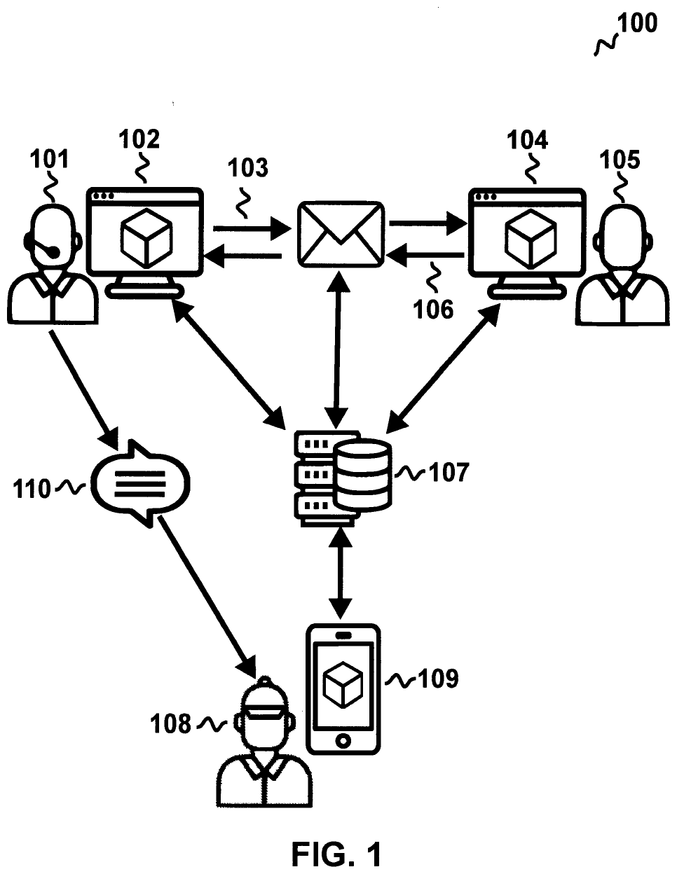

FIG. 1 illustrates a flow diagram of system 100 implementing an embodiment of the present invention. This system 100 allows customers 105 to visually select the desired location for their container on a map, thereby enhancing their ability to specify precise placement preferences during the container placement process.

To initiate the process, the dispatcher 101 utilizes the dispatcher interface 102 to input all necessary information for initializing a virtual map module. Once the dispatcher 101 enters the required details, a hyperlink is generated and sent to the customer 105 via email 103. Simultaneously, data is transmitted to the central server/database 107 for storage and processing.

Upon receiving email notification 103, the customer 105 opens the provided link directing them to interact with the system. The customer 105 can adjust container markers' position and orientation of container doors on the virtual map. Each movement of the container-marker updates the database 107 with the container's coordinates, orientation, zoom, and heading. Upon finalizing placement, the customer 105 submits the request, triggering a final update to the database 107.

Additionally, an email notification 106 is sent to the dispatcher 101, signaling completion of the process by the customer 105. Subsequently, the dispatcher 101 communicates with the designated driver 108 to convey placement details. The driver 108, equipped with the driver interface 110, accesses their own map to view the container placement exactly as specified by the customer 105. This seamless communication and visualization process among the dispatcher 101, the customer 105, and the driver 108 ensures efficient and accurate container placement.

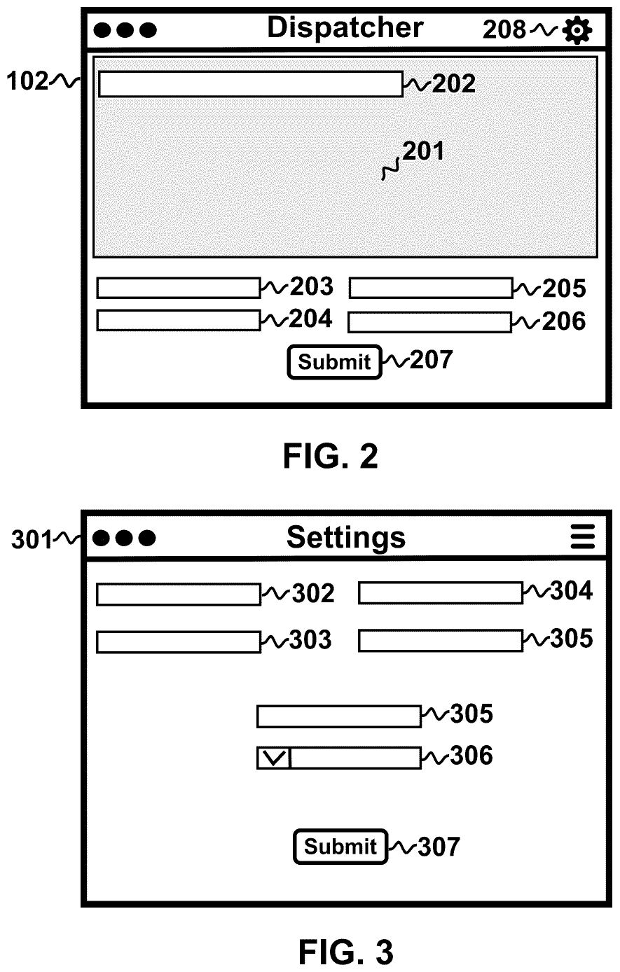

FIG. 2 illustrates the dispatcher interface 102, featuring a map configuration module 201. It comprises several input fields, including an address input field 202, enabling the dispatcher to specify the desired container placement location. As the address is entered, the system provides auto-complete suggestions and conducts geocoding to obtain corresponding map coordinates. Additional input fields such as email address 203, unique ID 204, container size 205, and type of container 206 allow for detailed specification of container-related information. A prominent submit control 207 facilitates the submission of container placement details. Upon activation, the entered information is transmitted to the database 107 for storage and processing.

Furthermore, the dispatcher interface encompasses a control 208 for accessing system settings. This feature provides dispatchers with flexibility, allowing configuration and customization of various aspects of the container placement system to align with their operational requirements and preferences.

FIG. 3 illustrates the dispatcher settings screen 301 allowing customization of various aspects of the container placement system.

The dispatcher settings screen 301 includes two input fields for configuring the container appearance: one for the container line color 302 and another for the container fill color 303. Dispatchers can adjust these settings to define the visual representation of containers on the map interface.

Similarly, input fields for truck line color 304 and truck fill color 305 allow customization of the appearance of the truck-visualization-marker, aiding in visualizing container delivery space requirements.

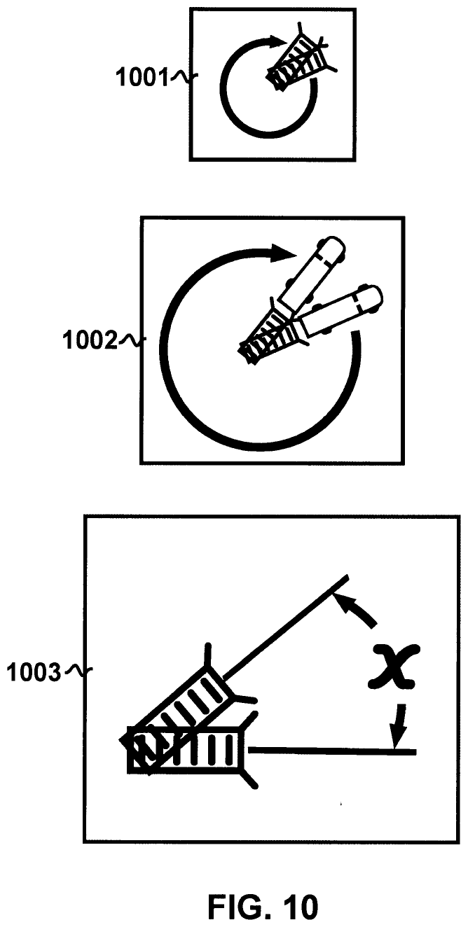

Additionally, a field 305 is provided for specifying the rotation variable, allowing dispatchers or companies to determine the extent to which customers 105 can rotate the container during the placement process. Further details regarding the rotation variable are discussed in FIG. 10.

Input field 306 enables the dispatcher 101 to designate access permissions for the customer map module. In one embodiment, the dispatcher 101 sends a hyperlink to the customer for accessing the map module, while in another embodiment, the customer 105 can directly access the map module.

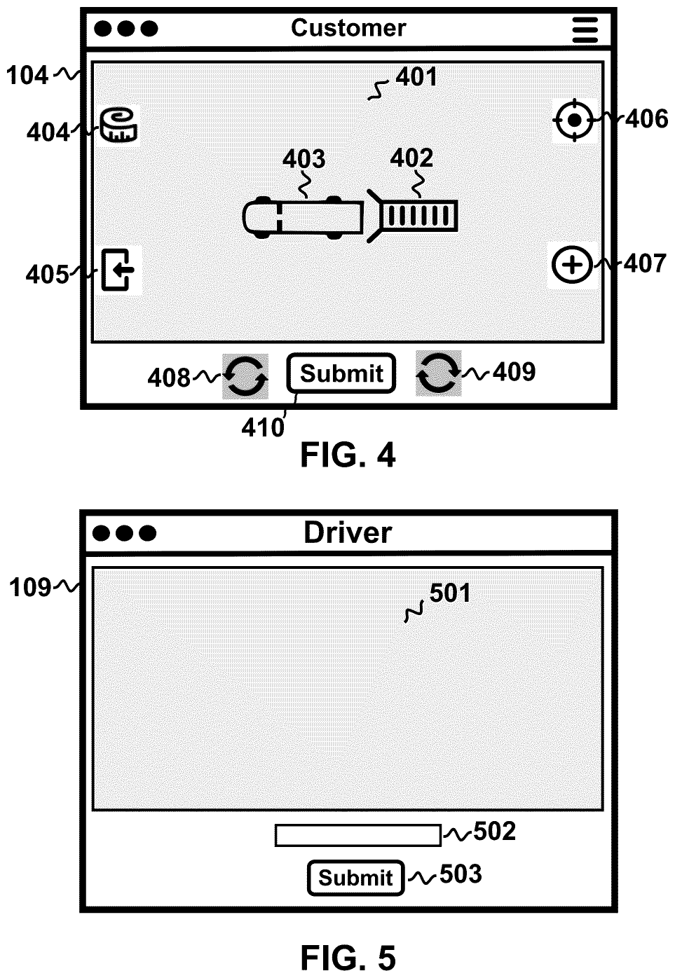

FIG. 4 depicts an example of the customer interface 104 with a customer map module 401, a pivotal component of the container placement process. At the center of the interface lies the container-marker 402 and the truck-visualization-marker 403. These dynamic markers are the focal points of system 100, empowering customers to finely tune container placement and gauge delivery space requirements effortlessly.

The interface is equipped with several controls to facilitate customer 105 interaction. Controls for rotating the container-marker clockwise 408 and counter-clockwise 409 are included, allowing customers to adjust the container marker's orientation with precision. The rotation degree is determined by the setting configured in the settings menu 301, typically set to 10 degrees and adjustable based on the company's preference.

The control to toggle the door direction 405 provides a convenient way for customers to flip the container orientation 180 degrees to suit their delivery requirements.

The show/hide control 404 for the truck-visualization-marker is a key feature, allowing customers to visualize the space needed for delivery and aiding in decision-making.

In some variations, the native heading control 406 allows customers to change the map view in 90-degree increments, with the container and/or truck-visualization-marker(s) orientation adjusting accordingly. Additionally, a control 407 is provided to add more containers if multiple containers are being delivered.

Finally, the submit control 410 concludes the interaction, transmitting the final placement data to the server 107 and sending an email notification 106 to the dispatcher 101 to notify them of the completed container placement process.

FIG. 5 illustrates an embodiment of the driver's interface 109 with a driver's map module 501. The driver's interface 109 features a straightforward input field for the driver 108 to enter the ID the input field 502 associated with the container placement request. Once the ID is entered, the driver 108 simply needs to activate the submit control 503 to initiate the process.

Upon submission, the map module 501 provides the driver 108 with a comprehensive view of the container placement as intended by the customer 105. This seamless transition ensures that the driver 108 sees the container placement exactly as the customer 105 placed it, facilitating an efficient and accurate container delivery.

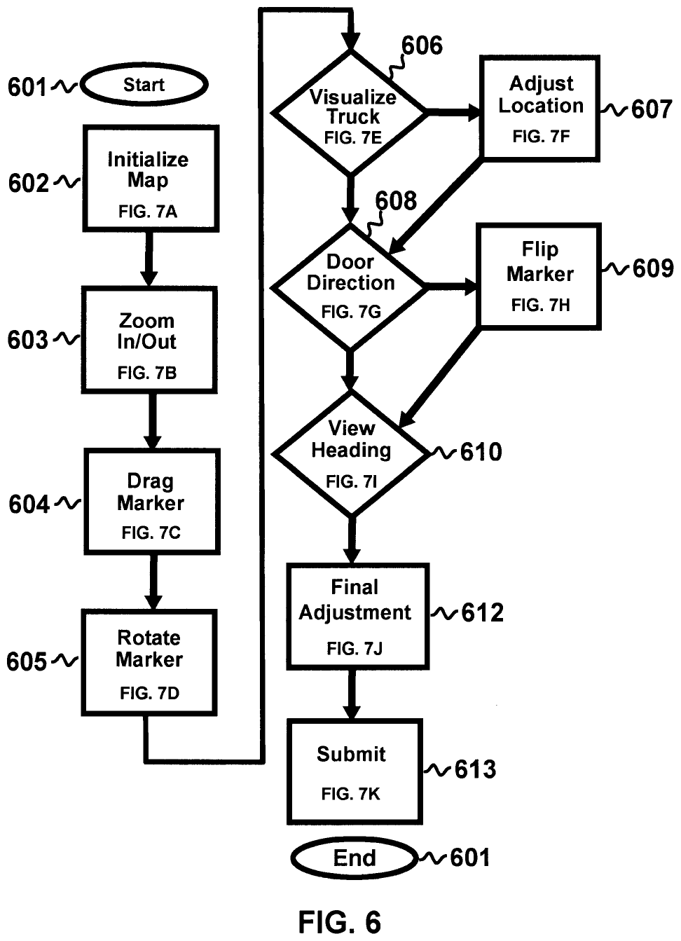

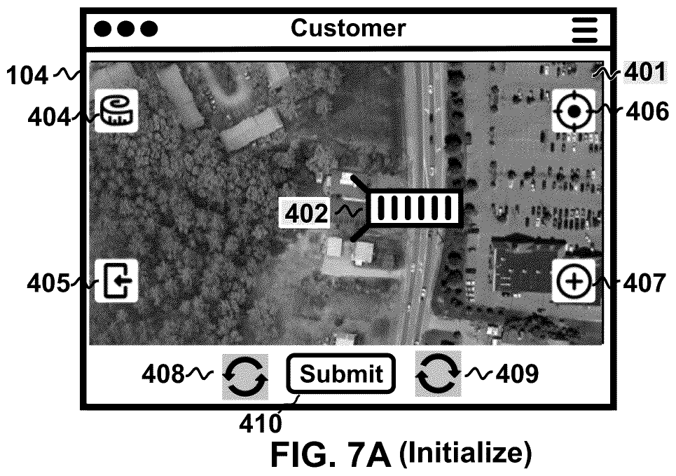

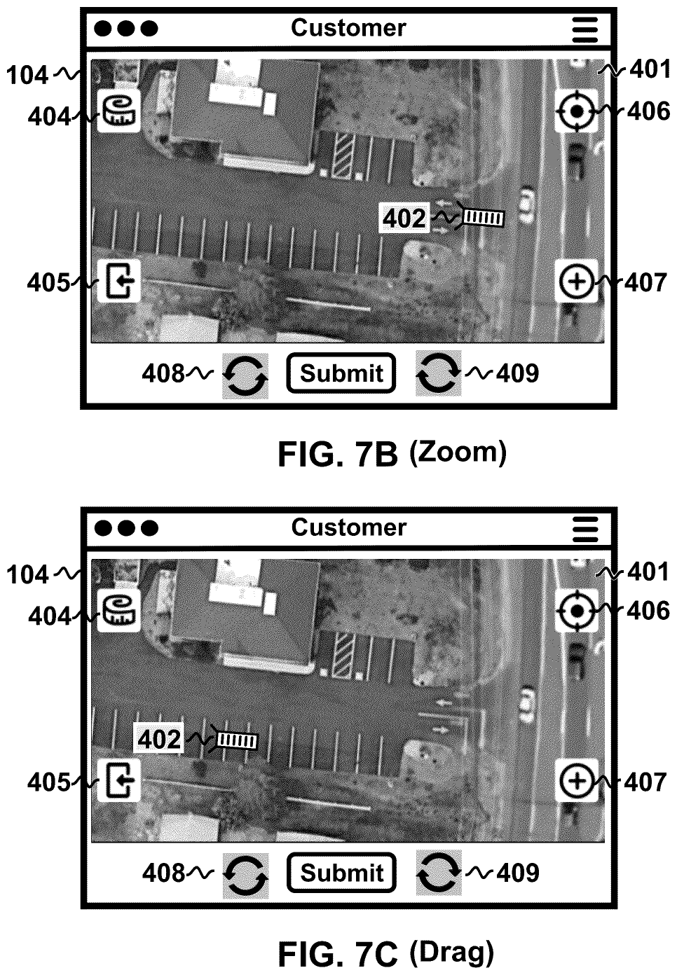

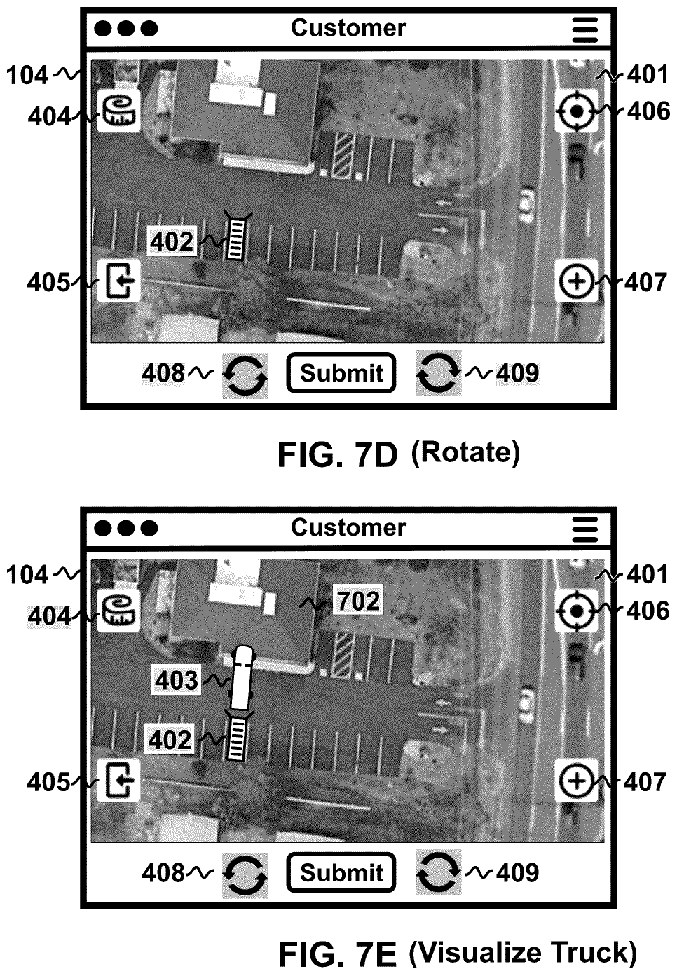

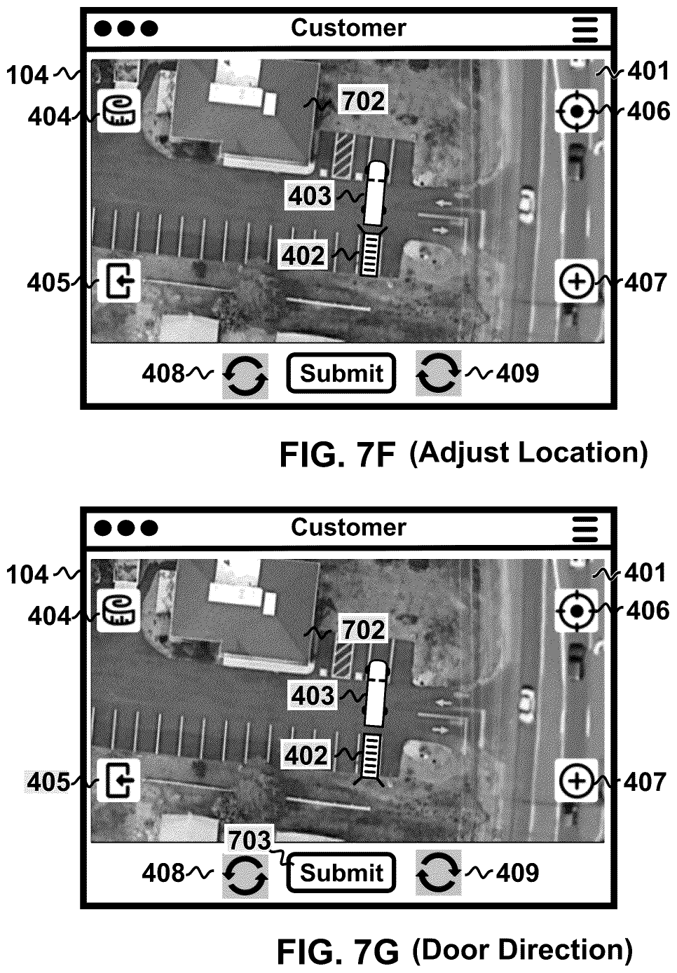

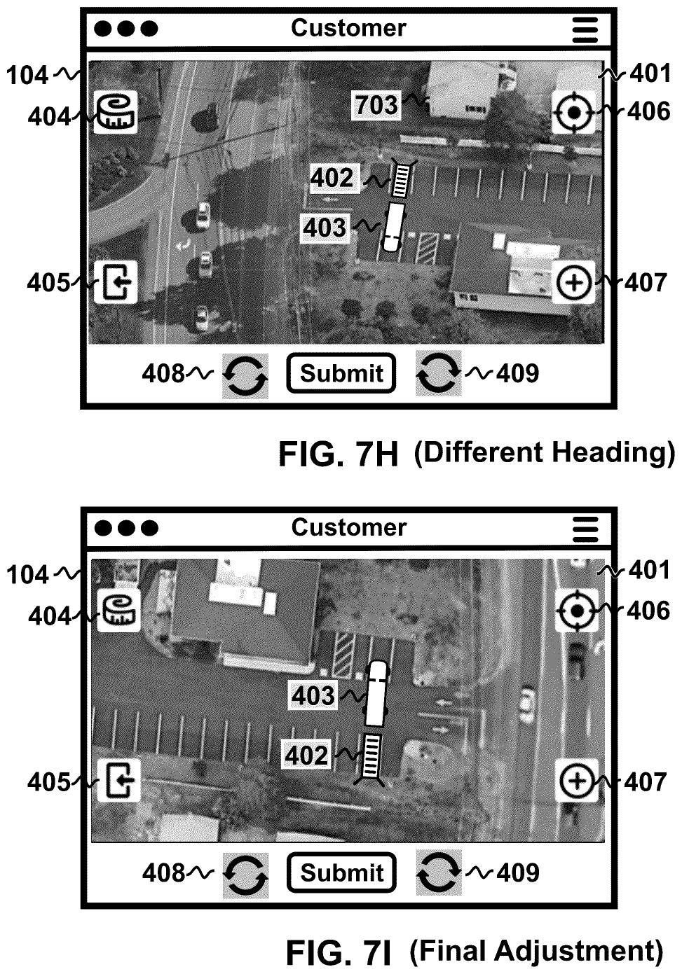

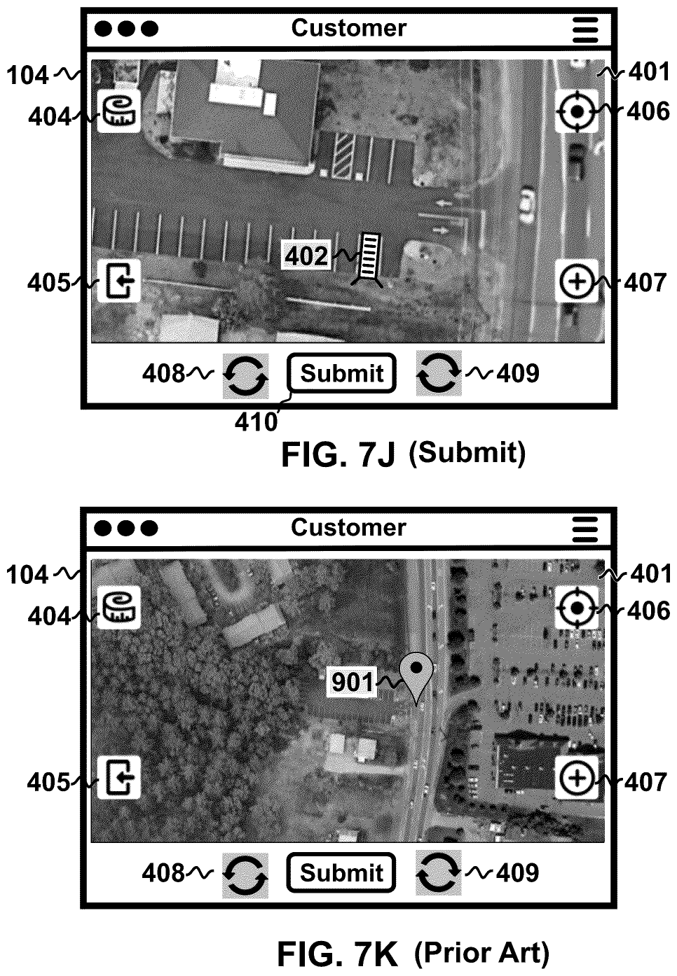

FIG. 6 provides a visual overview of the interactive container placement and visualization method according to one embodiment of the present invention. It outlines the sequential steps involved, serving as a foundation for the detailed descriptions that follow. These descriptions, accompanied by FIGS. 7A-7K, will explore the functionalities of each step and illustrate their practical implementation. Combined, these elements facilitate a clear understanding of the method.

The process starts at 601, and the map initializes 602 on the customer's interface. The customer's first step is to zoom in 603 on the map to get a closer view of the location. Next, the customer can seamlessly drag 604 the container-marker to their desired location on the map. For precise alignment, the customer can rotate 605 the container-marker to their preferred orientation. Additionally, they have the option to visualize 606 a delivery truck on the map to evaluate if there is enough room to deliver. Considering the truck visualization or other factors, the customer may further refine and adjust 607 the container-marker's position for optimal placement. Next, the customer checks if the container's doors are facing the desired direction 608 for efficient usage. With convenient controls, the customer can flip the marker 609, thereby changing the door direction. Altering the map heading 610 offers the flexibility to view the area from different angles, with markers adjusting accordingly. The customer can now make final adjustments 611 to the container marker position. Upon satisfaction, the customer submits 612 the final placement, triggering data transmission to the database and a confirmation email is sent to the dispatcher to conclude the process 613.

It is worth noting that steps 603 to 611 outlined in the flowchart can be performed in any order, rather than strictly adhering to the sequential order presented. Additionally, GPS technology is utilized to update marker coordinates and orientation in real-time after each manipulation.

FIGS. 7A through 7J provide detailed illustrations accompanying the steps outlined in the flowchart. These visual representations offer further insight into the container placement method, enhancing understanding and facilitating seamless implementation.

FIG. 7A demonstrates the initialization phase, where the map interface displays a container-marker 402, indicating the container's designated address for placement. The customer can see a general overview of the desired placement location.

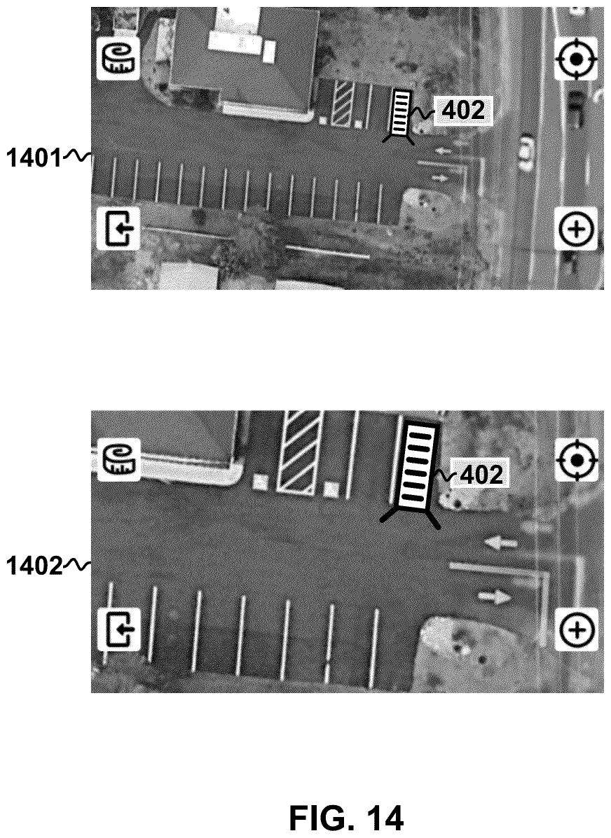

FIG. 7B, illustrates how the customer 105 can utilize the zoom function to enlarge the customer map module 401, improving visibility of the surrounding area. Notably, this capability enables the customer 105 to concentrate on specific locations and make precise adjustments to the container placement. The scaling of both the container-marker and the truck-visualization-marker sizes, as discussed further in FIG. 14, ensures accurate representation of their true sizes as the map zooms in.

FIG. 7C demonstrates how the customer 105 can drag the container-marker 402 to a new location in the customer map module 401. This action allows the customer 105 to reposition the container to their desired location, facilitating optimal placement based on logistical considerations.

FIG. 7D shows the customer 105 utilizing rotation controls 408 and 409 to adjust the container-marker 402 orientation. This feature allows precise alignment of the container's opening with the desired direction or orientation for optimal placement. The control enables clockwise or counter-clockwise rotation in predetermined 10-degree increments, enhancing precision in positioning.

FIG. 7E displays when the customer activates the truck-visualization-marker control by selecting 404, an additional marker representing a truck or a truck-visualization-marker 403 appears on the customer map module 401. The primary purpose of this embodiment of the truck visualizer control 404 is to provide the customer 105 with a visual representation of the truck's size and the space required for container delivery.

By displaying the truck-visualization-marker, the customer 105 can accurately assess potential obstacles such as trees or buildings 702 that may impede the delivery process. This feature enhances the customer's 105 understanding of the delivery requirements and helps them make informed decisions. In this example, the customer 105 can see there is not enough room to deliver the container to the placement location.

FIG. 7F shows the customer 105 can then drag the container and truck-visualization-markers to a new location in the customer map module 401, allowing them to circumvent obstacles or ensure unobstructed delivery access. This adjustment guarantees that the delivery truck has adequate space to deliver the container without encountering any hindrances.

Importantly, when the container-marker 402 or the truck-visualization-marker 403 is moved, both move together in synchronization, as further discussed in FIG. 12.

FIG. 7G is an example that the customer 105 can also easily adjust the orientation of the container to meet specific requirements. In FIG. 7F, where the container doors are initially facing the truck, the customer may need them to face the building 703. This adjustment is easily accomplished by utilizing the dedicated control 405 to rotate the container door by 180 degrees. Moreover, the door direction control 405 simplifies communication between the customer, the dispatcher, and the driver, as it clearly indicates how the customer 105 desires the orientation of the container doors.

FIG. 7H shows the customer 105 can change the map heading using control 406. This feature allows the customer 105 to view the surrounding area from different angles, aiding in decision-making for container placement. When the map heading is changed, the system rotates the markers 402, 403 to match the new heading.

FIG. 7I displays that the customer 105 has the option to make final adjustments to marker positions and orientations to ensure optimal placement based on logistical considerations. This step involves fine-tuning the marker positions and orientations to achieve the desired container placement on the customer map module 401.

FIG. 7J outlines the concluding step, which entails clicking the submit button 410 to transmit the finalized container placement data, including the positions of the container-marker 402 to the database. Upon submission, the system 100 updates the database with this information, along with any other relevant data. Additionally, the system 100 automatically sends an email notification 106 to the dispatcher 101, informing them of the completed submission. This feature streamlines communication and ensures the dispatcher 101 can effectively communicate with the driver 108, facilitating efficient container delivery logistics.

FIG. 7K illustrates an example of prior art, showcasing a basic map marker interface that lacks advanced functionality. While the marker may display the address, it fails to provide precise information regarding the desired location and orientation of the container within the property. Such markers lack the capabilities necessary for delivering storage or refuse containers and may result in containers being placed in incorrect locations or with doors facing the wrong direction, leading to inefficiencies in the placement process. Comparing FIG. 7J to FIG. 7K will clearly demonstrate the effectiveness of the system.

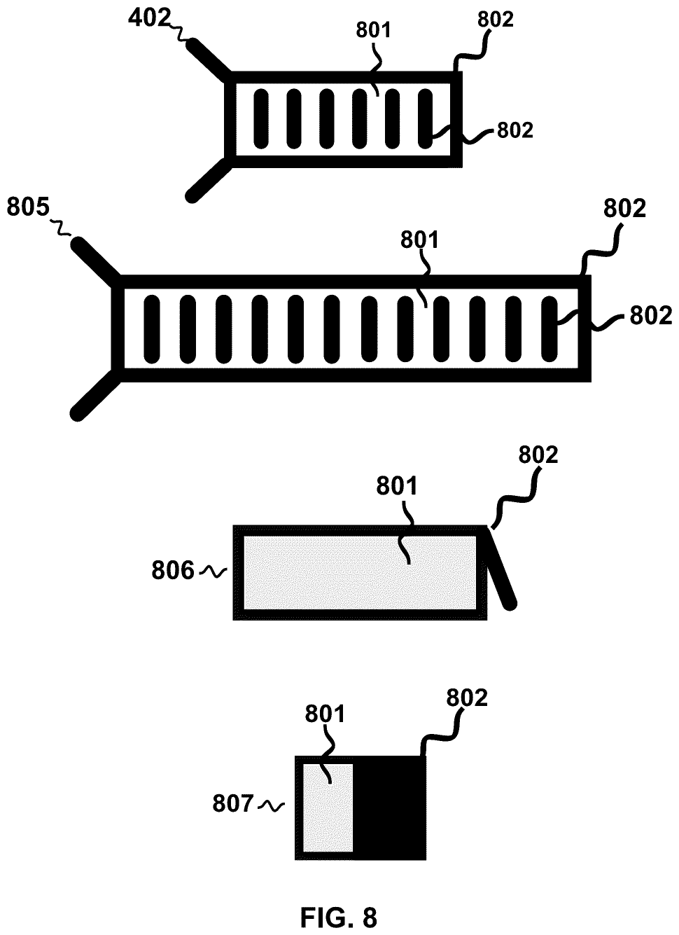

FIG. 8 showcases the system's versatility in accommodating various container and dumpster types while allowing dispatchers to customize their visual appearance on the map interface. This illustration presents examples of container types, including a 20′ storage container 402, a 40′ storage container 805, a roll-off dumpster 806, and a standard dumpster 807.

For each container/dumpster type, the system offers line and fill color customization options. Dispatchers can personalize their container placement experience by selecting their preferred colors through designated input fields 302, 303 for both lines and fills of containers and dumpsters. These selections are reflected in real-time on the map interface, enhancing clarity and the customer's experience.

The system 100 provides a wide range of color options to cater to individual preferences and allows for the creation of informative and visually clear map displays. This flexibility ensures that dispatchers 101 can tailor the container placement system to meet their specific needs, whether it be for logistical planning, aesthetic purposes, or reflecting their companies' color or branding.

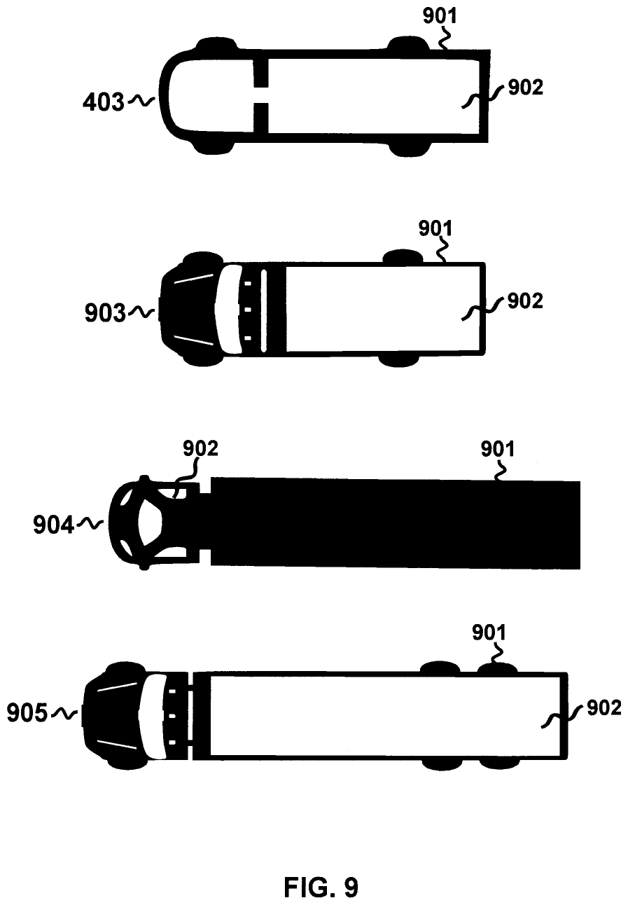

FIG. 9 showcases the system's 100 capability to accommodate various truck types and enables dispatchers 101 to customize the visual appearance of truck-visualization-markers 403 on the customer map module 402. This emphasis on truck visibility and size is crucial for optimizing delivery logistics and ensuring clear communication between dispatchers 101 and drivers 108.

The illustration presents examples of truck placement options, including a shorter truck model suitable for navigating tight spaces 403, a truck with an extended cab for additional crew capacity 903, and larger tractor-trailer configurations ideal for long-distance hauls 904, 905. This versatility ensures that the system can effectively manage diverse delivery requirements.

Similar to the container/dumpster markers in FIG. 8, each truck type offers line and fill color customization options 901, 902. Dispatchers can personalize the truck placement experience by selecting preferred colors through designated input fields 304, 305.

The system 100 provides a wide range of size and color options. This flexibility empowers dispatchers to tailor the system to the customers' 105 requirements, ultimately promoting a clear visual reference of what is required to deliver a container.

FIG. 10 illustrates one embodiment of the system's marker rotation capabilities when the customer 105 uses the ‘rotate left’ 408 or ‘rotate right’ 409 controls. 1001 depicts an example of a container undergoing rotation on the map interface. This functionality allows the customer 105 to precisely adjust the container's orientation according to their preferences. The container-marker 402 can be rotated in a full circle, from 1 degree to 360 degrees, in either a clockwise or counter-clockwise direction. This granular control ensures customers 105 can achieve the exact container placement desired.

Illustration 1002 showcases an example of synchronized rotation. It depicts both a container-marker 402 and a truck-visualization-marker 403. When a customer 105 selects either the ‘rotate left’ 408 or ‘rotate right’ 409 control, the truck-visualization-marker rotates in sync with the container throughout the adjustment process, maintaining consistent alignment. This visual feedback helps customers 105 understand how the actual delivery truck will be positioned relative to the rotated container.

Illustration 1003 highlights the concept of adjustable rotation increments. The system offers the flexibility to adjust the rotation increment size (e.g., 10 degrees, 45 degrees) to suit user preferences, allowing for both coarse and precise container-marker 401 positioning. While 10-degree increments are generally suitable, as discussed earlier, the system offers flexibility to adjust these increments to meet individual preferences.

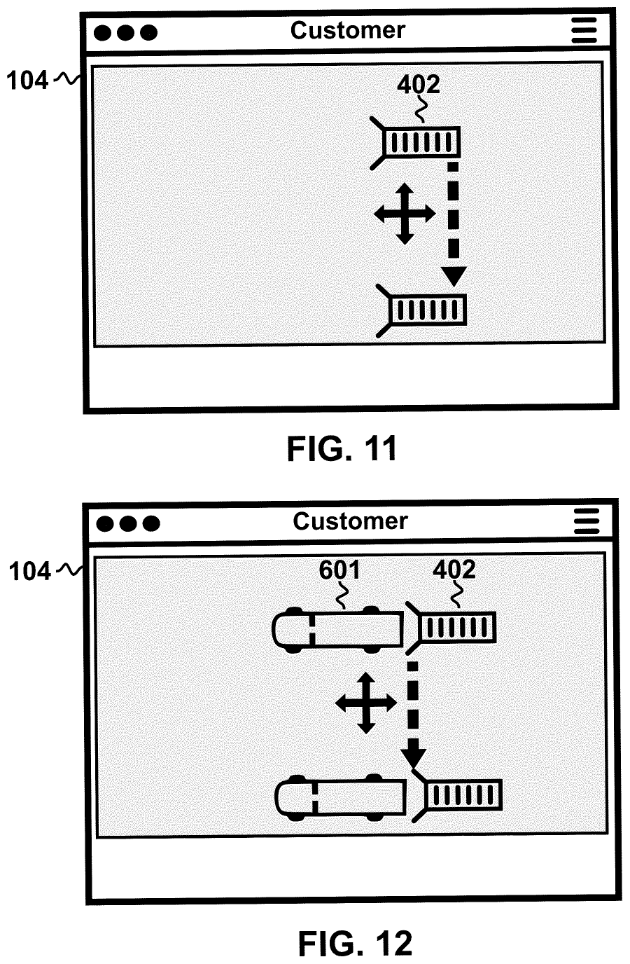

FIG. 11 illustrates the container 402 being relocated downward across the map interface 401 via the standard controls provided by the map module. This feature empowers customers 105 to precisely position the container at their desired location with ease. Notably, as customers 105 drag the container-marker, the system dynamically updates the coordinates to reflect its new position on the map.

By enabling customers 105 to drag and position the container using familiar map navigation tools, the system facilitates intuitive container placement. Customers 105 can effortlessly visualize and plan the optimal placement of containers, ensuring efficient logistics and effective space utilization.

Additionally, the dragging action depicted in FIG. 11 triggers a real-time update process within the system. As the customer 105 repositions the container representation, the system dynamically updates the associated location data in the database to reflect the new latitude and longitude coordinates on the map. This functionality allows for precise container placement and ensures the database maintains an accurate record of the container's location throughout the placement process.

FIG. 12 illustrates the synchronized dragging functionality. As the container 402 is dragged on the map interface 401, its corresponding truck-visualization-marker 403 moves in tandem, maintaining consistent alignment. Similarly, dragging the truck-visualization-marker 403 repositions the container-marker synchronously. This intuitive interaction allows customers 105 to easily visualize and plan the optimal placement of both containers and trucks, streamlining logistics and maximizing space utilization.

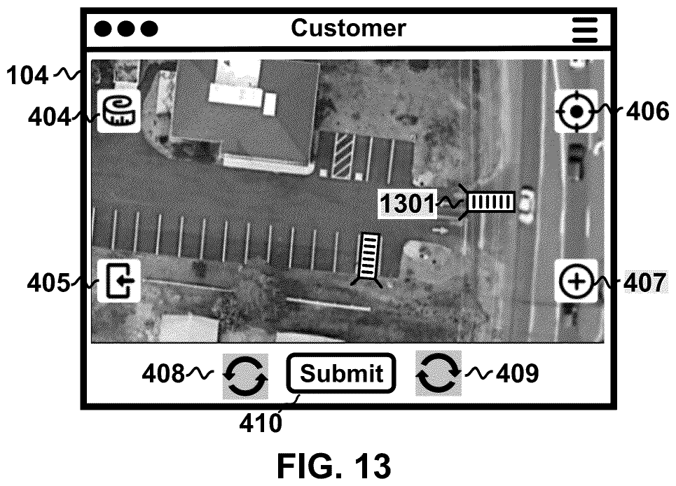

FIG. 13 showcases an embodiment of an add container control 407 designed to allow customers 105 to add and view additional container-markers 1301 on the customer interface 104. This feature provides customers 105 with the flexibility to display more container-markers if necessary, allowing them to visualize multiple container placements simultaneously.

The system 100 is designed to seamlessly incorporate additional container units into the database as needed, ensuring scalability and adaptability to accommodate varying customer 105 requirements. By clicking on the add container control 407, customers 105 can effortlessly access and view the added container-markers 1301 on the map, thereby enhancing their ability to manage and plan container placements effectively.

While not always required, this functionality offers customers 105 the option to expand the display of container-markers, providing them with a comprehensive overview of container placements and facilitating informed decision-making.

FIG. 14 demonstrates the scaling behavior of the markers in response to changes in zoom level. In one embodiment, the system 100 dynamically scales the container-marker 402 relative to the map viewport as the zoom level is adjusted. This scaling process ensures that the markers accurately reflect their actual sizes relative to the map display area, thereby facilitating precise visualization of container placement and truck accessibility.

The scaling is performed based on a proportional scaling algorithm implemented within the system. This algorithm adjusts the size of the markers dynamically according to the zoom level, maintaining their relative sizes in relation to the map display. By employing this proportional scaling algorithm, the system ensures that the markers maintain accurate proportions regardless of the zoom level, thereby enhancing the customer 105 experience and facilitating efficient container placement and visualization.

In sample 1401, the map is zoomed to scale 20, while in sample 1402, it is zoomed to scale 21. Notably, in each example, the container-marker 402 maintains its relative size in comparison to the map, regardless of the zoom level. Additionally, it's important to highlight that the truck-visualization-marker also adjusts its size accordingly.

What is claimed:

1. A system for interactive container placement in a map module, comprising:
a dispatcher interface for inputting information regarding container placement, including the generation and emailing of a hyperlink that opens a customer map module;
a customer interface to open the customer map module, enabling adjustment of a container-marker's position and orientation;
real-time updating of a database with the container's coordinates, orientation, zoom, and heading during customer interaction;
transmission of an email notification to the dispatcher upon completion of the placement process by the customer; and
a driver interface allowing the designated driver to view the container placement as specified by the customer.

2. The system of claim 1, further comprising a control to show/hide a truck-visualization-marker within the map module, enabling customers to visualize the space needed for container delivery by displaying a virtual representation of a truck or delivery vehicle on the map interface.

3. The system of claim 1, further including controls within the map module that allow customers to rotate the container-marker clockwise and counterclockwise in predetermined increments.

4. The system of claim 1, further comprising a control within the map module allowing customers to flip the container-marker 180 degrees, ensuring optimal door positioning for efficient container placement.

5. The system of claim 1, wherein when the map zoom level is adjusted by the customer, both the container-marker and the truck-visualization-marker dynamically scale to reflect their actual sizes relative to the map viewport, ensuring accurate representation of container placement and truck accessibility regardless of the zoom level.

6. The system of claim 1, where the container-marker visually represents a location on the map associated with functions such as storage, refuse disposal, or other activities requiring the placement of an open-ended container.

7. The system of claim 1, further comprising:
a button within the map interface for adding additional container-markers; and
functionality ensuring marker orientation adjusts synchronously with changes in map heading.

8. The system of claim 1, wherein when the truck-visualization-marker is displayed within the map interface, movement of the container-marker by a customer results in synchronous movement of the truck-visualization-marker, and vice versa, ensuring coordinated visualization of container placement and truck space requirements.

9. The system of claim 1, where the dispatcher interface includes:
settings for marker and truck fill and line colors;
options for preset orientation intervals; and
configuration for access rights to the map configuration module.

10. A method for interactive container placement and visualization, comprising:
initializing a map module on a customer interface;
adjusting the zoom level of the map module using a zoom control; and
allowing a customer to drag the container-marker to adjust its position on the map.

11. The method of claim 10, further comprising:
enabling the customer to rotate the container-marker in predetermined increments for precise orientation adjustments.

12. The method of claim 10, further comprising:
displaying a truck visualization marker feature within the map module, allowing customers to visualize the space needed for container delivery by displaying a virtual representation of a truck or delivery vehicle on the map interface.

13. The method of claim 10, further comprising:
providing a toggle control within the map module to flip the container-marker 180 degrees, thereby changing the orientation of container doors if present.

14. The method of claim 10, further comprising:
providing a control within the map module for the customer to change the heading of the map interface, dynamically adjusting the orientation of the container-marker and the truck visualization marker to synchronize with the changed heading of the map interface.

15. The method of claim 10, further comprising:
allowing the customer to make final adjustments to the container-marker position, rotation, or orientation in any order during the placement process.

16. The method of claim 10, further comprising enabling the customer to finalize the container placement process by hitting a submit control, triggering the transmission of placement data stored in the database and notification to relevant parties.

17. The method of claim 10, further comprising:
dynamically scaling a container-marker and a truck visualization marker to reflect their actual sizes relative to the map viewport as the zoom level is adjusted;
allowing the customer to perform the steps of adjusting the zoom level, scaling the container-marker and truck visualization marker, dragging the container-marker, and adding additional container-markers in any order during the container placement process.

18. A non-transitory computer-readable medium having instructions stored thereon that, when executed by a processor, cause the processor to perform operations comprising:
initializing a map module on a customer interface;
enabling a customer to manipulate a container-marker within the map module;
real-time updating of a database upon manipulation of the container-marker by the customer;
transmission of an email notification to the dispatcher upon completion of the placement process by the customer;
enabling the designated driver to view the container placement as specified by the customer;
and facilitating communication between the dispatcher, customer, and designated driver to ensure efficient and accurate container placement.
